(19) United States
(12) Patent Application Publication
(10) Pub. No.: US 2015/0328542 A1
(43) Pub. Date: Nov. 19, 2015

(54) GAME INTERACTION SYSTEM AND GAME INTERACTION METHOD

(71) Applicant: AVerMedia TECHNOLOGIES, INC., New Taipei City (TW)

(72) Inventors: Chien-Ming YEH, NEW TAIPEI CITY (TW); Chien-Chung CHIANG, NEW TAIPEI CITY (TW); Po-Wen CHEN, NEW TAIPEI CITY (TW); Yan-Zhang CHEN, NEW TAIPEI CITY (TW)

(21) Appl. No.: 14/712,921

(22) Filed: May 15, 2015

(30) Foreign Application Priority Data
May 16, 2014 (TW) 103117327

(51) Int. Cl. A63F 13/24; A63F 13/21

(52) U.S. Cl. CPC A63F 13/24; A63F 13/21

(57) ABSTRACT

A game interaction system includes at least one game controller and a game console. The game controller is configured for detecting at least one physiological signal of at least one user, and for generating and outputting at least one corresponding physiological signal data according to the physiological signal. The game console is configured for receiving and analyzing the physiological signal data, and for generating at least one corresponding physiological signal parameter. The game console is further configured for determining whether the physiological signal parameter reaches at least one setting value, and if yes, the game console performs at least one corresponding instruction. A game interaction is disclosed herein as well.

### RELATED APPLICATIONS

This application claims priority to Taiwanese Application Serial No. 103117327, filed May 16, 2014, which is herein incorporated by reference.

### BACKGROUND

1. Technical field

The present disclosure relates to a game interaction system and a game interaction method. More particularly, the present disclosure relates to a game interaction system and a game interaction method which utilize a game controller to detect the physiological signals of the user.

2. Description of Related Art

As the development of game industry, the designs of modern computer games or video games are more and more sophisticated with abundant contents and magnificent visual and sound effects. The industry keeps working on improving the reality and interactivity of the games.

The improvements of the games usually cause users to indulge in the games. The users may spend too much time playing the games without sufficient rest, which endangers the health of the user. Some sudden death cases are reported that users stayed up for too much time playing the game and died of over-exhaustion.

### SUMMARY

In one aspect, the present disclosure is related to a game interaction system. The game interaction system includes at least one game controller and a game console. The game controller is configured for detecting at least one physiological signal of at least one user, and for generating and outputting at least one corresponding physiological signal data according to the physiological signal. The game console is configured for receiving and analyzing the physiological signal data, and for generating at least one corresponding physiological signal parameter. The game console is further configured for determining whether the physiological signal parameter reaches at least one setting value, and if yes, the game console performs at least one corresponding instruction.

In another aspect, the present disclosure is related to a game interaction method. The game interaction method includes the following steps: utilizing at least one game controller to detect at least one physiological signal of at least one user; generating and outputting at least one corresponding physiological signal data according to the physiological signal; utilizing a game console to receive and analyze the at least one physiological signal data, and to generate at least one corresponding physiological signal parameter; utilizing the game console to determine whether the physiological signal parameter reaches at least one setting value; and if yes, utilizing the game console to perform at least one corresponding instruction.

By integrating the systems for measuring physiological signals (e.g., electrocardiography signals, body temperature, breath, the carbon dioxide concentration, sweat, and so on) into a game controller, corresponding game functions can be executed according to the physiological status of the user. Consequently, the game becomes more interesting and realistic. Moreover, the physiological signals of the user are analyzed to determine whether the user suffers from fatigue. If the user is detected to suffer from fatigue, a warning message will be outputted or the game will be terminated. Consequently, the user will not overindulge in the game and hence endangerment to the health of the user can be avoided.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a game interaction system in accordance with one embodiment of the present disclosure;

FIG. 2 is a schematic diagram of a game controller in accordance with one embodiment of the present disclosure;

FIG. 3 is a schematic diagram of a game controller in accordance with one embodiment of the present disclosure;

FIG. 4 is a schematic diagram of a game controller in accordance with one embodiment of the present disclosure;

FIG. 5 is a schematic diagram of a game controller in accordance with one embodiment of the present disclosure;

FIG. 6 is a schematic diagram of a game controller in accordance with one embodiment of the present disclosure; and

FIG. 7 is a flow chart of a game interaction method in accordance with one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

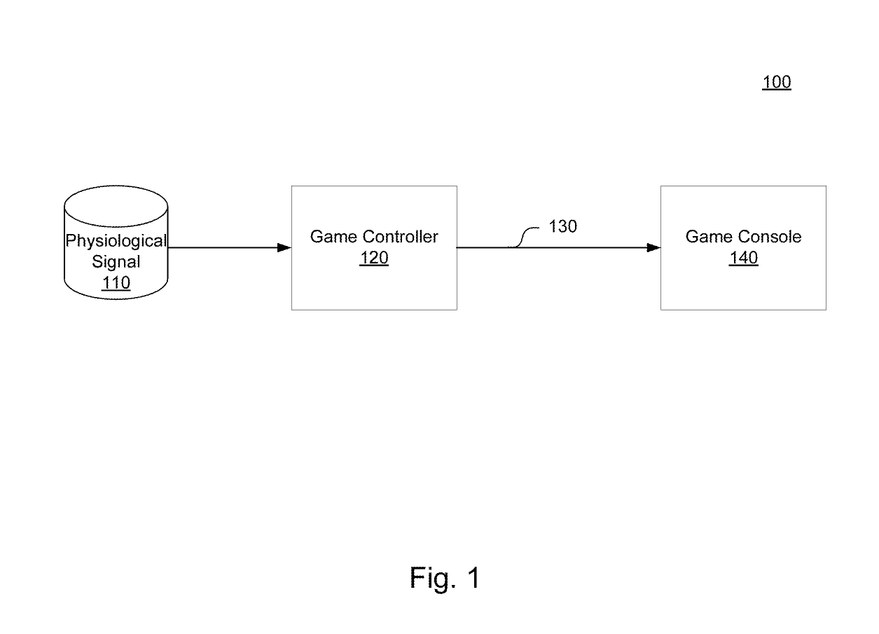

Reference is made first to FIG. 1. FIG. 1 is a schematic diagram of a game interaction system 100 in accordance with one embodiment of the present disclosure. The game interaction system 100 includes at least one game controller 120 and a game console 140. In one embodiment of the present disclosure, the game controller 120 is a mouse, a gamepad, a joystick, a headset or a combination thereof. In another embodiment of the present disclosure, the game console 140 is a personal computer, a laptop, a tablet computer, a smart phone or a video game console (e.g., Xbox One, Wii, Wii U or PS4).

The game controller 120 is configured for detecting at least one physiological signal 110 of at least one user (not depicted), and for generating and outputting at least one corresponding physiological signal data 130 according to the physiological signal 110. In one embodiment of the present disclosure, the physiological signal 110 is a electrocardiography signal, body temperature, breath, the carbon dioxide concentration of the gas exhaled by the at least one user, sweat or a combination thereof.

The game console 140 is configured for receiving and analyzing the physiological signal data 130, and for generating at least one corresponding physiological signal parameter (not depicted). The game controller 120 can be electrically connected with the game console 140 by utilizing a transmission cable, or they can be connected wirelessly. The game console 140 is further configured for determining whether the physiological signal parameter reaches at least one setting value (not depicted). If yes, the game console 140 performs at least one corresponding instruction.

In one embodiment of the present disclosure, the abovementioned setting value is a heart beats value, a heart rate value, a electrocardiography sample, a body temperature value, a body temperature changing rate value, a breath times value, a breath rate value, a carbon dioxide concentration of the gas exhaled by the user, a sweat amount value or a combination thereof. In another embodiment of the present disclosure, the abovementioned instruction includes a change of a corresponding game character, activating a hidden stage, outputting a warning message, terminating the game, turning the game console off and a combination thereof.

In an example, the game controller 120 is configured for detecting the electrocardiography signal, breath and the carbon dioxide concentration of the gas exhaled by the user, and for generating and outputting corresponding electrocardiography signal data and breath signal data. The game console 140 is configured for receiving the abovementioned electrocardiography signal data and breath signal data, and for generating a corresponding electrocardiography sample, a corresponding breath rate value and a corresponding carbon dioxide concentration value of the gas exhaled by the user as the abovementioned physiological signal parameters. The game console 140 compares the abovementioned electrocardiography sample, breath rate value and carbon dioxide concentration value with a electrocardiography sample setting value, a breath rate setting value and a carbon dioxide concentration setting value, respectively. If the abovementioned electrocardiography sample, breath rate value, carbon dioxide concentration value, or its combination reaches the abovementioned corresponding setting values, the game console 140 determines that the user suffers from fatigue, and outputs a warning message accordingly. The warning message warns the user that he/she suffers from fatigue and suggests the user to stop playing the game. In another example, if the game console 140 determines that the use suffers from fatigue, the game console 140 terminates the game or turn itself off.

In another example, the game controller 120 is configured for detecting the electrocardiography signal and the breath of the user, and for generating and outputting corresponding electrocardiography signal data and breath signal data. The game console 140 is configured for receiving the abovementioned electrocardiography signal data and breath signal data, and for generating the corresponding heart rate value and breath rate value as the abovementioned physiological signal parameters. The game console 140 compares the abovementioned heart rate value and breath rate value with a heart rate setting value and breath rate setting value, respectively. If the abovementioned heart rate value, breath rate value or its combination reaches the abovementioned corresponding setting values, the game console 140 changes the status of game characters accordingly (e.g., an improved attacking ability status or an improved defending ability status).

In still another example, the game controller 120 is configured for detecting the sweat of the user, and for generating and outputting corresponding sweat signal data. The game console 140 is configured for receiving the abovementioned sweat signal data, and for generating the corresponding sweat amount value as the abovementioned physiological signal parameters. The game console 140 compares the abovementioned sweat amount value with a sweat amount setting value. If the abovementioned sweat amount setting value reaches the abovementioned corresponding setting value, the game console 140 changes the status of a game character to a status of sweating.

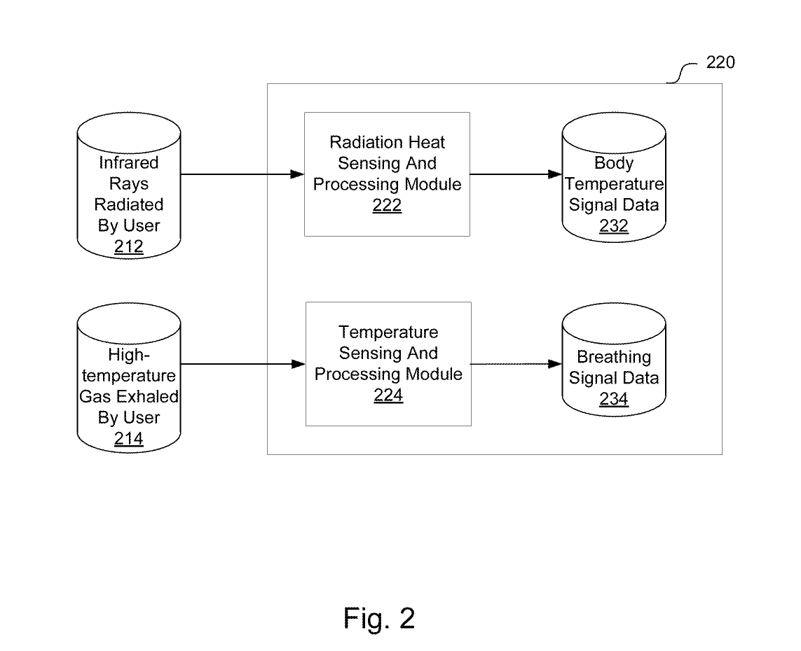

Reference is made also to FIG. 2. FIG. 2 is a schematic diagram of a game controller 220 in accordance with one embodiment of the present disclosure. The game controller 220 can be the game controller 120 illustrated in FIG. 1, but is not limited in this regard. The game controller 220 includes a radiation heat sensing and processing module 222 and a temperature sensing and processing module 224. The radiation heat sensing and processing module 222 is configured for detecting the body temperature of the user according to the wavelength of infrared rays radiated by the user 212, and for generating body temperature signal data 232. The temperature sensing and processing module 224 is configured for detecting the breath of the user according to the high-temperature gas exhaled by the user 214, and for generating breathing signal data 234. The body temperature signal data 232 and the breathing signal data 234 can be the physiological signal data 130 illustrated in FIG. 1, but are not limited in this regard.

In an example, the game controller is a headset, the head set is configured for utilizing a radiation heat sensing and processing module 222 disposed in the earphone of the headset to measure the wavelength of the infrared near the earhole of the user. The radiation heat sensing and processing module 222 converts the measured wavelength to a corresponding temperature value to detect the body temperature of the user, and generates body temperature signal data 232. The abovementioned headset is further configured for utilizing a temperature sensing and processing module 224 disposed in the microphone of the headset to detect the breath of the user according to the high-temperature gas exhaled by the user 214. The temperature sensing and processing module 224 measures the breath rate of the user by sensing the temperature difference between the high-temperature gas exhaled by the user 214 and the air inhaled by the user to generate breathing signal data 234.

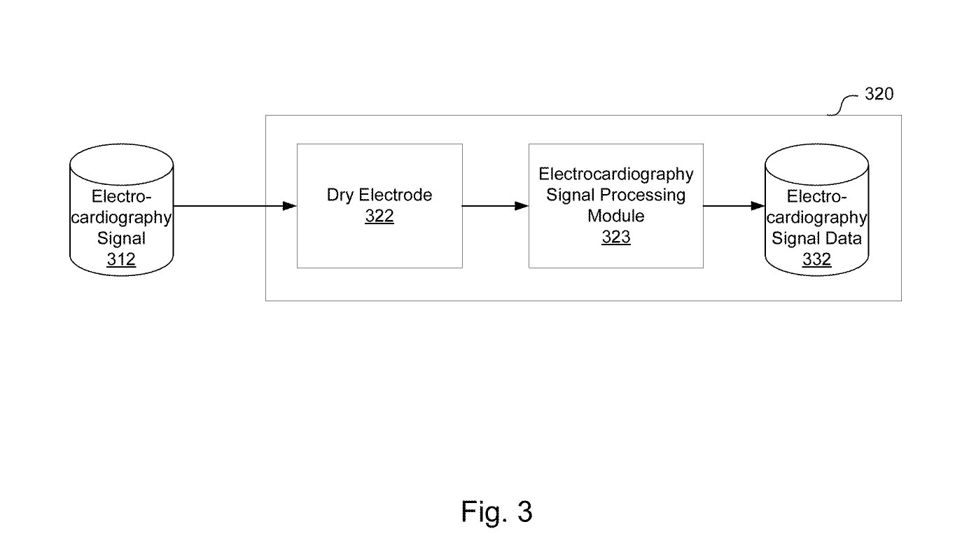

Additional reference is made to FIG. 3. FIG. 3 is a game controller 320 in accordance with one embodiment of the present disclosure. The game controller 320 can be the game controller 120 illustrated in FIG. 1, but is not limited in this regard.

The game controller 320 includes at least one dry electrode 322 and the electrocardiography signal processing module 323. The dry electrode 322 is configured for detecting at least one electrocardiography signal 312 of the user. The electrocardiography signal processing module 323 is configured for converting the electrocardiography signal 312 to electrocardiography signal data 332. The electrocardiography signal data 332 can be the physiological signal data illustrated in FIG. 1, but is not limited in this regard.

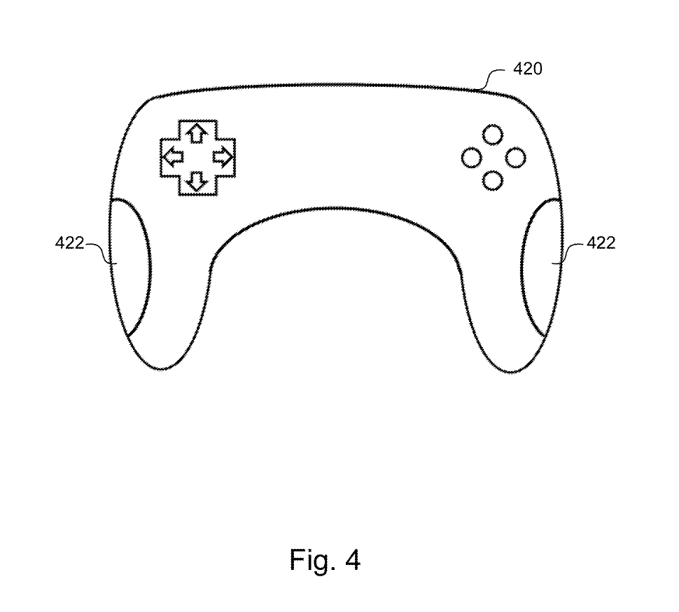

Reference is now made to FIG. 4. FIG. 4 is a game controller 420 in accordance with one embodiment of the present disclosure. The game controller 420 can be the game controller 320 illustrated in FIG. 3, but is not limited in this regard.

In the present embodiment, the game controller 420 is a gamepad. The game controller 420 is configured for utilizing the dry electrode 422 (the dry electrode 422 can be the dry electrode 322 illustrated in FIG. 3, but is not limited in this regard) disposed on the left and right parts of the gamepad to detect the electrocardiography signal of the user, and for transmitting the abovementioned electrocardiography signal to the electrocardiography signal processing module 323 as illustrated in FIG. 3 such that the electrocardiography signal is converted to the electrocardiography signal data.

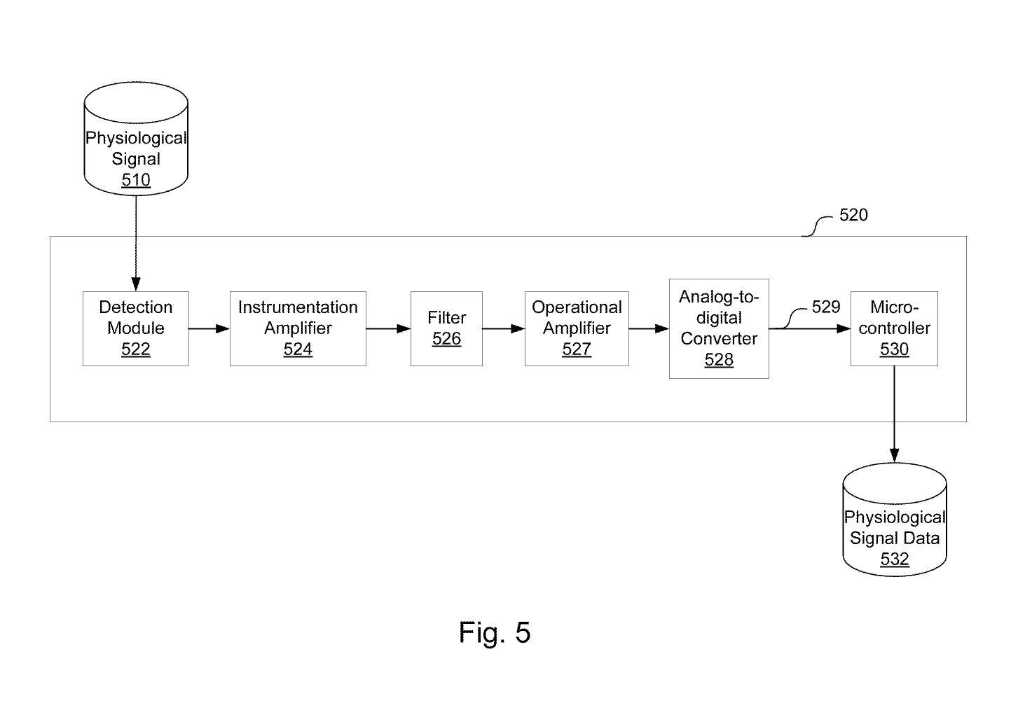

Reference is further made to FIG. 5. FIG. 5 is a game controller 520 in accordance with one embodiment of the present disclosure. The game controller 520 can be the game controller 120 illustrated in FIG. 1, but is not limited in this regard. The game controller 520 includes a detection module 522, an instrumentation amplifier 524, a filter 526, an operational amplifier 527, an analog-to-digital converter 528 and a micro-controller 530.

The detection module 522 is configured for detecting the physiological signal 510. The instrumentation amplifier 524 is electrically connected with the detection module 522. The instrumentation amplifier 524 is configured for amplifying the physiological signal 510. The filter 526 is electrically connected with the instrumentation amplifier 524. The filter 526 is configured for filtering out noises of the physiological signal 510. The operational amplifier 527 is electrically connected with the filter 526. The operational amplifier 527 is configured for improving the gain of the filtered physiological signal. The analog-to-digital converter 528 is electrically connected with the operational amplifier 527. The analog-to-digital converter 528 is configured for converting the gain-improved physiological signal to at least one digital physiological signal 529. The micro-controller 530 is electrically connected with the analog-to-digital converter 528. The micro-controller 530 is configured for converting the digital physiological signal 529 to the physiological signal data 532. The physiological signal 510 and the physiological signal data 532 can be the physiological signal 110 and the physiological signal data 130 illustrated in FIG. 1, respectively, but is not limited in this regard.

In an example, the filter 526 is a second order Sallen-Key active filter, which includes a Butterworth high-pass filter and a low-pass filter. In another example, the operational amplifier 527 is a programmable operational amplifier configured for amplifying the physiological signal 510 such that the physiological signal 510 matches the maximum input voltage of the of the analog-to-digital converter 528.

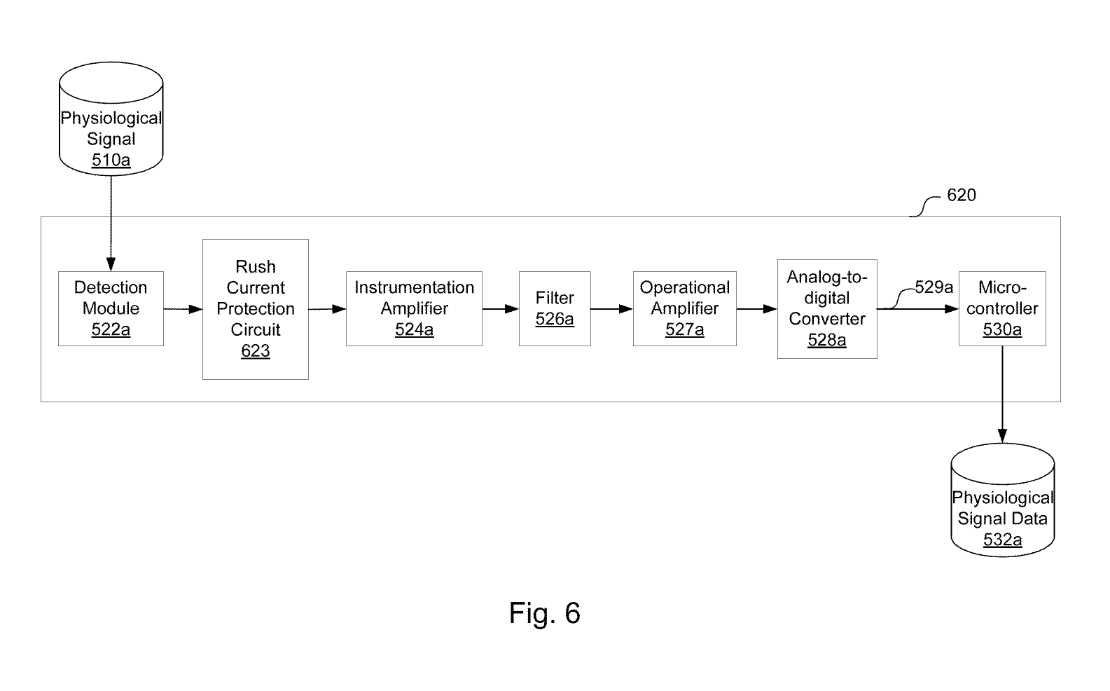

Reference is also made to FIG. 6. FIG. 6 is a game controller 620 in accordance with one embodiment of the present disclosure. The game controller 620 can be the game controller 120 illustrated in FIG. 1, but is not limited in this regard.

The detection module 522a, the instrumentation amplifier 524a, the filter 526a, the operational amplifier 527a, the analog-to-digital converter 528a and the micro-controller 530a can be the detection module 522, the instrumentation amplifier 524, the filter 526, the operational amplifier 527, the analog-to-digital converter 528 and the micro-controller 530 illustrated in FIG. 5. Their functions and operations are similar and hence are not described again herein. Compared with the game controller 520 illustrated in FIG. 5, in this embodiment, the game controller 620 further includes a rush current protection circuit 623. The rush current protection circuit 623 is electrically connected with the detection module 522a. The rush current protection circuit 623 is configured for protecting the human body from being injured by the rush currents.

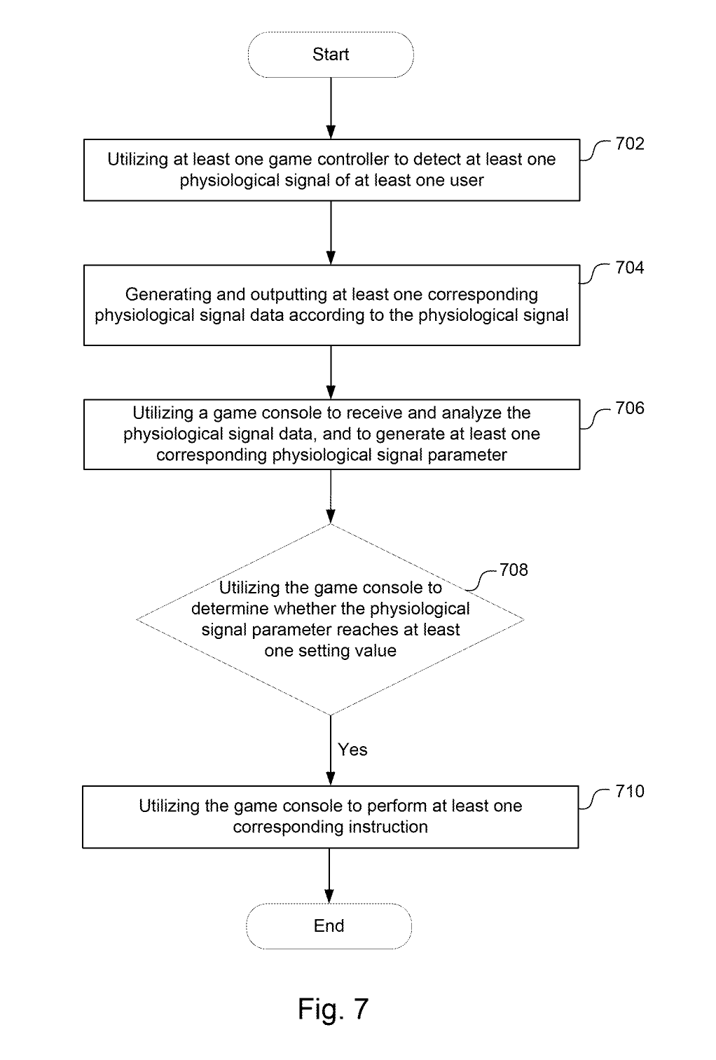

Reference is now made to FIG. 7. FIG. 7 is a flow chart of a game interaction method in accordance with one embodiment of the present disclosure. The game interaction method may be implemented by the game interaction system 100 illustrated in FIG. 1, but is not limited in this regard. For convenience and clarity, it is assumed that the game interaction method is implemented by the game interaction system 100 illustrated in FIG. 1.

In step 702, the game controller 120 is utilized to detect the physiological signal 110 of the user.

In step 704, the corresponding physiological signal data 130 is generated and outputted according to the physiological signal 110.

In step 706, the game console 140 is utilized to receive and analyze the physiological signal data 130, and to generate at least one corresponding physiological signal parameter.

In step 708, the game console 140 is utilized to determine whether the abovementioned physiological signal parameter reaches at least one setting value.

If yes, then in step 710, the game console 140 is utilized to perform at least one corresponding instruction.

The above illustrations include exemplary operations, but the operations are not necessarily performed in the order shown. Operations may be added, replaced, changed order, and/or eliminated as appropriate, in accordance with the spirit and scope of various embodiments of the present disclosure.

By integrating the systems for measuring physiological signals (e.g., electrocardiography signals, body temperature, breath, the carbon dioxide concentration, sweat, and so on) into a game controller, corresponding game functions can be executed according to the physiological status of the user. Consequently, the game becomes more interesting and realistic. Moreover, the physiological signals of the user are analyzed to determine whether the user suffers from fatigue. If the user is detected to suffer from fatigue, a warning message will be outputted or the game will be terminated. Consequently, the user will not overindulge in the game and hence endangerment to the health of the user can be avoided.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A game interaction system comprising:
at least one game controller configured for detecting at least one physiological signal of at least one user, and for generating and outputting at least one corresponding physiological signal data according to the at least one physiological signal; and
a game console configured for receiving and analyzing the physiological signal data, and for generating at least one corresponding physiological signal parameter, and for determining whether the at least one physiological signal parameter reaches at least one setting value, and if yes, the game console performs at least one corresponding instruction.

2. The game interaction system of claim 1, wherein the at least one game controller is a mouse, a gamepad, a joystick, a headset or a combination thereof.

3. The game interaction system of claim 1, wherein the headset comprises:
a radiation heat sensing and processing module configured for detecting the body temperature of the at least one user according to the wavelength of infrared rays radiated by the at least one user, and for generating body temperature signal data; and
a temperature sensing and processing module configured for detecting the breath of the at least one user according to the high-temperature gas exhaled by the at least one user, and for generating breathing signal data, wherein the physiological signal data comprises the body temperature signal data and the breathing signal data.

4. The game interaction system of claim 1, wherein the game controller comprises:
at least one dry electrode configured for detecting at least one electrocardiography signal of the at least one user; and
an electrocardiography signal processing module configured for converting the at least one electrocardiography signal to electrocardiography signal data, wherein the physiological signal data comprises the electrocardiography signal data.

5. The game interaction system of claim 1, wherein the game controller comprises:
a detection module configured for detecting the physiological signal;
an instrumentation amplifier electrically connected with the detection module, the instrumentation amplifier being configured for amplifying the at least one physiological signal;
a filter electrically connected with the instrumentation amplifier, the filter being configured for filtering out noises of the at least one physiological signal;
an operational amplifier electrically connected with the filter, the operational amplifier being configured for improving the gain of the at least one filtered physiological signal;
an analog-to-digital converter electrically connected with the operational amplifier, the analog-to-digital converter being configured for converting the gain-improved at least one physiological signal to at least one digital physiological signal; and
a micro-controller electrically connected with the analog-to-digital converter, the micro-controller being configured for converting the at least one digital physiological signal to the at least one physiological signal data.

6. The game interaction system of claim 1, wherein the at least one physiological signal is a electrocardiography signal, body temperature, breath, the carbon dioxide concentration of the gas exhaled by the at least one user, sweat or a combination thereof.

7. The game interaction system of claim 1, wherein the setting value is a heart beats value, a heart rate value, a electrocardiography sample, a body temperature value, a body temperature changing rate value, a breath times value, a breath rate value, a carbon dioxide concentration of the gas exhaled by the at least one user, a sweat amount value or a combination thereof.

8. The game interaction system of claim 1, wherein the instruction comprises a change of a corresponding game character, activating a hidden stage, outputting a warning message, terminating the game, turning the game console off and a combination thereof.

9. A game interaction method comprising:
utilizing at least one game controller to detect at least one physiological signal of at least one user;
generating and outputting at least one corresponding physiological signal data according to the at least one physiological signal;
utilizing a game console to receive and analyze the at least one physiological signal data, and to generate at least one corresponding physiological signal parameter;
utilizing the game console to determine whether the at least one physiological signal parameter reaches at least one setting value; and
if yes, utilizing the game console to perform at least one corresponding instruction.

10. The game interaction method of claim 9, wherein the at least one game controller is a mouse, a gamepad, a joystick, a headset or a combination thereof.

11. The game interaction method of claim 9, wherein generating and outputting the at least one corresponding physiological signal data according to the at least one physiological signal further comprises:
detecting the body temperature of the at least one user according to the wavelength of infrared rays radiated by the at least one user, and generating body temperature signal data; and
detecting the breath of the at least one user according to the high-temperature gas exhaled by the at least one user, and generating breathing signal data, wherein the physiological signal data comprises the body temperature signal data and the breathing signal data.

12. The game interaction method of claim 9, wherein the game controller comprises at least one dry electrode, and generating and outputting the at least one corresponding physiological signal data according to the at least one physiological signal further comprising:
converting at least one electrocardiography signal of the at least one user detected by the at least one dry electrode to electrocardiography signal data, wherein the physiological signal data comprises the electrocardiography signal data.

13. The game interaction method of claim 9, wherein generating and outputting the at least one corresponding physiological signal data according to the at least one physiological signal further comprising:
amplifying the at least one physiological signal;
filtering out noises of the at least one physiological signal;
improving the gain of the at least one filtered physiological signal;
converting the gain-improved at least one physiological signal to at least one digital physiological signal; and
converting the at least one digital physiological signal to the at least one physiological signal data.

14. The game interaction method of claim 9, wherein the at least one physiological signal is a electrocardiography signal, body temperature, breath, the carbon dioxide concentration of the gas exhaled by the at least one user, sweat or a combination thereof.

15. The game interaction method of claim 9, wherein the setting value is a heart beats value, a heart rate value, a electrocardiography sample, a body temperature value, a body temperature changing rate value, a breath times value, a breath rate value, a carbon dioxide concentration of the gas exhaled by the at least one user, a sweat amount value or a combination thereof.

16. The game interaction method of claim 9, wherein the instruction comprises a change of a corresponding game character, activating a hidden stage, outputting a warning message, terminating the game, turning the game console off or a combination thereof.
